(19) United States
(12) Patent Application Publication
(10) Pub. No.: US 2023/0245148 A1
(43) Pub. Date: Aug. 3, 2023

(54) METHODS AND APPARATUSES FOR DETERMINING PRODUCT ASSORTMENT

(71) Applicant: Walmart Apollo, LLC, Bentonville, AR (US)

(72) Inventors: Kenneth Kuhn, Pasadena, CA (US); Satish Shivajirao Lomte, Bentonville, AR (US); Karthik Kumaran, Sunnyvale, CA (US); Ryan Anthony Jones, Bentonville, AR (US); Mayank Uniyal, Uttarakhand (IN); Peter Jie Yang, Sunnyvale, CA (US); Jacy Zeng, Alhambra, CA (US); Avinash Thangali, New York, NY (US); Taizhou Li, San Jose, CA (US)

(21) Appl. No.: 17/592,259

(22) Filed: Feb. 3, 2022

(51) Int. Cl. G06Q 30/02; G06Q 10/06

(52) U.S. Cl. CPC G06Q 30/0202; G06Q 10/0637

(57) ABSTRACT

A system for determining recommended product assortments for a retail environment includes at least one computing device that obtains store layout data, product data and forecast data. The forecast data characterizes projected sales information for the products described in the product data. The computing device also obtains demand transference data characterizing changes in demand for one or more products when a different product is unavailable and obtains product replenishment data characterizing a cost to re-stock products. The computing device also determines a recommended product assortment for the products described in the product data for each store described in the store layout data based on the forecast data, the demand transference data, and the product replenishment data and then displays the recommended product assortment.

### TECHNICAL FIELD

The disclosure relates generally to methods and apparatuses for determining product assortment and, more specifically, to methods and apparatuses for automatically determining and providing product assortment recommendations via an interactive electronic interface.

### BACKGROUND

At least some organizations, such as retail organizations, determine product assortments that will be provided in its retail outlets such as in retail stores. Such retail outlets include floor space, racks, shelving, and other displays on which products are stored, displayed and provided for purchase to customers. Retailers can decide which products to stock, display and sell to customers at any given time. Often, however, such decisions are made on a periodic basis because changes to the types, quantities, brands, variations and like can take a significant amount of cost and time to implement in a retail environment. It is important, therefore, to make decisions on the product assortments that will maximize the business strategies and goals of the organization since it will often be a significant amount of time before changes to the product assortment can be implemented.

For some retailers, the decisions regarding product assortment are very difficult because the retail environment can be large and the retailer can offer hundreds or thousands of different products in a single location. In some existing or traditional methods of determining product assortments, individuals or groups of individuals make such decisions using experience or historical information. Such existing or traditional methods suffer from many drawbacks including the failure to account for or to properly incorporate the interactions of different products on competing or related products. Still further, existing or traditional methods can fail to properly or accurately account for costs that can be influenced by changing product assortments in a retail environment. The interactions between the decisions in product assortment can be very complex such that an individual or group of individuals cannot accurately or satisfactorily make such decisions to optimize the business strategies and goals of an organization. There exists a need, therefore, for improved methods and apparatuses for determining product assortments.

### SUMMARY

The embodiments described herein are directed to apparatuses and methods for determining product assortment recommendations. Such product assortment recommendations may be used to describe which products should be included in a product assortment at a retail store. The product assortment recommendations can be determined by a product assortment recommender system that includes a product assortment workbench through which a user can input customizations. The product assortment recommendations can be optimized for each store and/or can be optimized for clusters of similar stores. The optimized product assortment recommendations can be based on product sales forecasts, product replenishment costs, demand transference as well as other product information.

In accordance with various embodiments, exemplary systems may be implemented in any suitable hardware or hardware and software, such as in any suitable computing device. For example, in some embodiments, a computing device is configured to obtain store layout data, product data and forecast data. The forecast data may characterize projected sales information for the products described in the product data. The computing may be further configured to obtain demand transference data characterizing changes in demand for one or more products when a different product is unavailable and to obtain product replenishment data characterizing a cost to re-stock products. The computing device may determine a recommended product assortment for the products described in the product data for each store described in the store layout data based on the forecast data, the demand transference data, and the product replenishment data. The computing device may also display the recommended product assortment.

In one aspect, the recommended product assortment is determined by an optimization engine configured to optimize a product sales function.

In another aspect, the computing device may display an input graphical user interface (GUI) that includes one or more input fields configured to obtain one or more assortment inputs, the one or more assortment inputs characterizing one or more strategic business considerations.

In another aspect, the one or more strategic business considerations includes a weight of units sold versus revenue versus profit.

In another aspect, the input graphical user interface (GUI) may include a replenishment slider configured to allow a user to change the weight given to the product replenishment data when the recommended product assortment is determined.

In another aspect, the computing device may also group the recommended product assortments into two or more store clusters.

In another aspect, two or more store clusters are determined based on one or more store characteristics and one or more distribution limitations.

In some embodiments of the present disclosure, a method of providing product assortment recommendations is provided. The method may include obtaining store layout data, product data and forecast data. The forecast data may characterize projected sales information for the products described in the product data. The method may also include obtaining demand transference data characterizing changes in demand for one or more products when a different product is unavailable and obtaining product replenishment data characterizing a cost to re-stock products. The method may also include determining a recommended product assortment for the products described in the product data for each store described in the store layout data based on the forecast data, the demand transference data, and the product replenishment data and displaying the recommended product assortment.

In some embodiments, a non-transitory computer readable medium is provided. The non-transitory computer readable medium may have instructions stored thereon, wherein the instructions, when executed by at least one processor, cause a device to perform operations that include obtaining store layout data, product data and forecast data. The forecast data may characterize projected sales information for the products described in the product data. The operations may also include obtaining demand transference data characterizing changes in demand for one or more products when a different product is unavailable and obtaining product replenishment data characterizing a cost to re-stock products. The operations may also include determining a recommended product assortment for the products described in the product data for each store described in the store layout data based on the forecast data, the demand transference data, and the product replenishment data and displaying the recommended product assortment.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of a product assortment recommender system in accordance with some embodiments;

FIG. 2 is a block diagram of an example product assortment computing device in accordance with some embodiments;

FIG. 3 is a block diagram of aspects of the product assortment recommender system of FIG. 1 in accordance with some embodiments;

FIG. 4 is a flow chart illustrating an example method of determining product assortment recommendations in accordance with some embodiments;

FIG. 5 is a block diagram illustrating aspects and data sources of the product assortment recommender systems in accordance with some embodiments;

FIG. 6 is a flow chart illustrating an example method of determining product assortment recommendations in accordance with some embodiments; and

FIG. 7 is an illustration of an example graphical user interface (GUI) of a product recommender workbench in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

As further explained below, the present disclosure is directed to apparatuses and methods for determining product assortment recommendations. The product assortment recommendations of the present can be used, for example, to describe an optimized layout for the display and sales of products in a retail environment such as in a retail store. In one example, the product assortment recommendations can be used to define how and where products should be positioned on the shelves of a retail store. The product assortment recommendations can be used to create a planogram, for example. The planogram can be a representation of a portion of a retail store environment such as a particular section of floor space, an aisle, a department or other area of the retail store. The planogram can define where each particular product should be positioned in the area of the retail store. In a retail store that include grocery items, for example, the planogram can define where products should be positioned on a shelf in a grocery isle. The planogram can define a product category, a product brand, a product size, and other product identifying information. The planogram can also define a location at which the product should be displayed such as a shelf location (first shelf, second shelf, etc.) and a number of facings on the shelf. The planogram can include other information for other areas of the store as may be appropriate for the particular types of displays, racks, shelves, enclosures, or the like that may be used to display products for sale to customers.

Existing or traditional methods of determining product assortment recommendations rely on individual experience or simple forecasts for individual product sales. Such existing or traditional methods do not contemplate the relationships between products and/or the complex interactions that can occur from a change to quantity or location of a product in a retail store. Other existing or traditional methods of determining product assortments may include simple replacement algorithms that perform the replacement of single products in product assortments. This one-by-one type of process cannot optimize product assortments and requires significant time and resources to perform. As such, existing and traditional methods of determining product assortment recommendations are not feasible nor useful to optimize product assortments in retail environments. Furthermore, these existing and traditional methods are ill-suited or cannot be used in the environment of a large scale retailer that has a large retail environment and may operate hundreds or thousands of retail stores in multiple locations with different demand and customer behaviors.

The apparatuses and methods of the present disclosure are improvements over existing and traditional methods. The apparatuses and methods of the present disclosure can use modern optimization tools to solve the complex problem created when determining product assortments. In addition, product assortment recommendations can be determined more quickly using less resources than existing methods. This allows product assortment recommendations to be determined iteratively using different inputs or requirements in order to consider changing or competing business strategies or business goals. The methods of the present disclosure can also incorporate considerations not previously used existing or traditional methods. The methods of the present disclosure can incorporate demand transfer and replenishment costs that have been ignored or under-utilized in existing and traditional methods of determining product assortments. Still further, the methods of the present disclosure can be implemented using a novel workbench that allows a user to input business considerations into the formulation of the product assortments.

The description below describes the use and implementation of the apparatuses and methods of the present disclosure in the context of a large scale retailer of consumer or grocery products. It should be appreciated, however, that aspects and examples of the present disclosure can be used in other contexts, industries and environments as well.

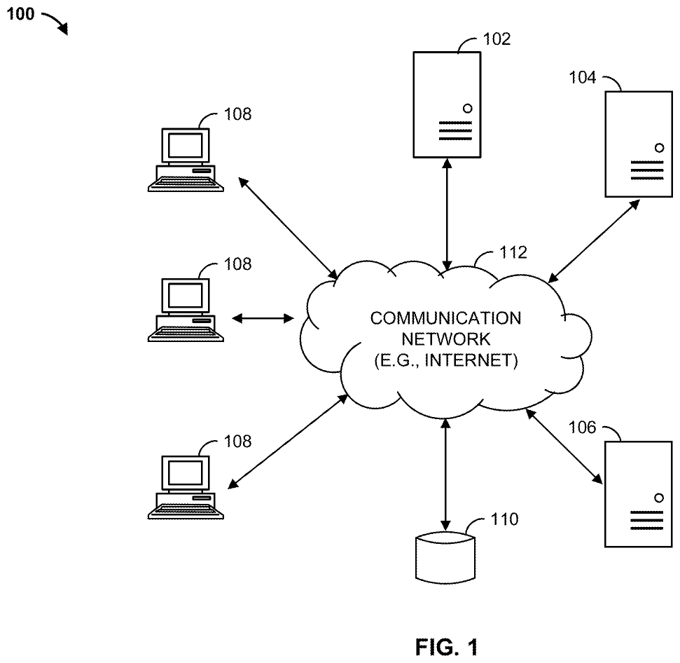

Turning to the drawings, FIG. 1 illustrates a block diagram of a product assortment recommender system 100 that includes a product recommender computing device 102 (e.g., a server, such as an application server), a delivery server 104 (e.g., a web server), a product information server 106, workstation(s) 108, and database 110 operatively coupled over network 112. Product assortment computing device 102, delivery server 104, product information server 106, workstation(s) 108 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 112.

In some examples, product assortment computing device 102 can be a computer, a workstation, a laptop, a server such as a cloud-based server, or any other suitable device. In some examples, each of workstations 108 can be desktop computer, a cellular phone, a smart phone, a tablet, a personal assistant device, a voice assistant device, a digital assistant, a laptop, a computer, or any other suitable device. In some examples, product assortment computing device 102 is operated by a retailer, and multiple workstations 108 are operated by merchants, buyers or other internal stakeholders of the retailer that have responsibility for ordering, buying and stocking retail stores with a variety of products.

The product assortment computing device 102 is operable to communicate with database 110 over communication network 112. For example, product assortment computing device 102 can store data to, and read data from, database 110. Database 110 can be a remote storage device, such as a cloud-based server, a memory device on another application server, a networked computer, or any other suitable remote storage. Although shown remote to product assortment computing device 102, in some examples, database 110 can be a local storage device, such as a hard drive, a non-volatile memory, or a USB stick.

Communication network 112 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 112 can provide access to, for example, the Internet.

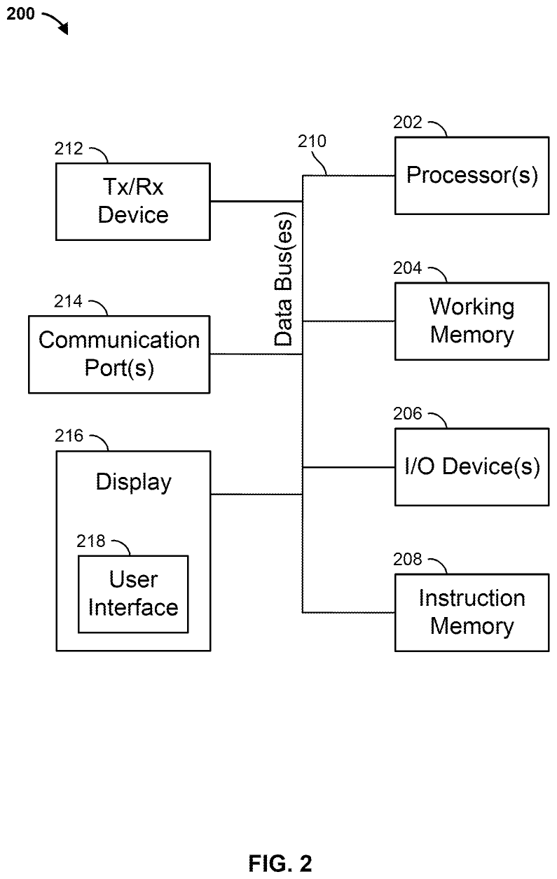

FIG. 2 illustrates an example computing device 200. The product assortment computing device 102, the delivery server 104, the product information server 106, and/or the workstation(s) 108 may include the features shown in FIG. 2. For the sake of brevity, FIG. 2 is described relative to the product assortment computing device 102. It should be appreciated, however, that the elements described can be included, as applicable, in the delivery server 104, the product information server 106, and/or the workstation(s) 108.

As shown, the product assortment computing device 102 can be a computing device 200 that may include one or more processors 202, working memory 204, one or more input/output devices 206, instruction memory 208, a transceiver 212, one or more communication ports 214, and a display 216, all operatively coupled to one or more data buses 210. Data buses 210 allow for communication among the various devices. Data buses 210 can include wired, or wireless, communication channels.

Processors 202 can include one or more distinct processors, each having one or more cores. Each of the distinct processors can have the same or different structure. Processors 202 can include one or more central processing units (CPUs), one or more graphics processing units (GPUs), application specific integrated circuits (ASICs), digital signal processors (DSPs), and the like.

Processors 202 can be configured to perform a certain function or operation by executing code, stored on instruction memory 208, embodying the function or operation. For example, processors 202 can be configured to perform one or more of any function, method, or operation disclosed herein.

Instruction memory 208 can store instructions that can be accessed (e.g., read) and executed by processors 202. For example, instruction memory 208 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 202 can store data to, and read data from, working memory 204. For example, processors 202 can store a working set of instructions to working memory 204, such as instructions loaded from instruction memory 208. Processors 202 can also use working memory 204 to store dynamic data created during the operation of product assortment computing device 102. Working memory 204 can be a random access memory (RAM) such as a static random access memory (SRAM) or dynamic random access memory (DRAM), or any other suitable memory.

Input-output devices 206 can include any suitable device that allows for data input or output. For example, input-output devices 206 can include one or more of a keyboard, a touchpad, a mouse, a stylus, a touchscreen, a physical button, a speaker, a microphone, or any other suitable input or output device.

Communication port(s) 214 can include, for example, a serial port such as a universal asynchronous receiver/transmitter (UART) connection, a Universal Serial Bus (USB) connection, or any other suitable communication port or connection. In some examples, communication port(s) 214 allows for the programming of executable instructions in instruction memory 208. In some examples, communication port(s) 214 allow for the transfer (e.g., uploading or downloading) of data, such as store layout data, product data, forecast data, demand transference data and/or product replenishment data.

Display 216 can display a user interface 218. User interfaces 218 can enable user interaction with the product assortment computing device 102. For example, user interface 218 can be a user interface that allows an operator to interact, communicate, control and/or modify different messages, settings, or features that may be presented or otherwise displayed to a user by a network-enabled tool such as workstation 108. The user interface 218 can include a slider bar, dialogue box, or other input field that allows the user to control, communicate or modify a setting, limitation or input that is used in the determination of product assortment recommendations. In addition, the user interface 218 can include one or more input fields or controls that allow a user to modify or control optional features or customizable aspects of the product assortment computing device and/or its product assortment recommendations. In some examples, a user can interact with user interface 218 by engaging input-output devices 206. In some examples, display 216 can be a touchscreen, where user interface 218 is displayed on the touchscreen. In other examples, display 216 can be a computer display that can be interacted with using a mouse or keyboard.

Transceiver 212 allows for communication with a network, such as the communication network 112 of FIG. 1. For example, if communication network 112 of FIG. 1 is a cellular network, transceiver 212 is configured to allow communications with the cellular network. In some examples, transceiver 212 is selected based on the type of communication network 112 user intent computing device 102 will be operating in. Processor(s) 202 is operable to receive data from, or send data to, a network, such as communication network 112 of FIG. 1, via transceiver 212.

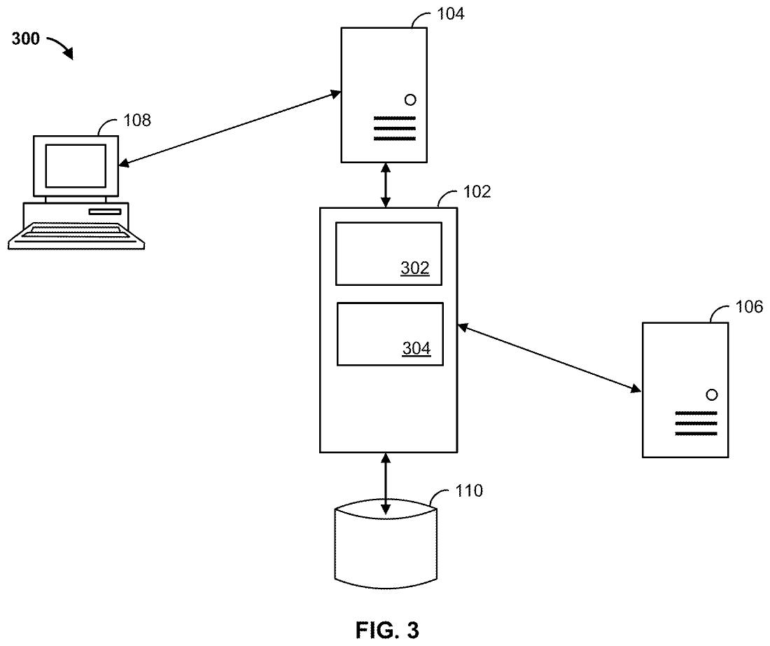

Turning now to FIG. 3, another example product assortment recommender system 300 is shown. The product assortment recommender system 300 can be similar to the product assortment recommender system 100 previously described. While not shown, the various elements of the product assortment recommender system 300 can be connected via a communication network such as network 112. In other examples, one or more of the elements of the product assortment recommender system 300 can alternatively be connected via wired or local connections.

As shown, the product assortment recommender system 300 includes product assortment computing device 102, delivery server 104, product information server 106, workstation 108 and database 110. Each of the product assortment computing device 102, delivery server 104, product information server 106, workstation 108 and database 110 can be connected to each to share data and/or information via a suitable communication network. The workstation 108 can be operated by a user that has a need to obtain product assortment recommendations. Such a user can be a merchant, buyer, or other user that has responsibility for determining the products that are displayed and sold in a retail environment such as a retail store. The user can access and obtain product assortment recommendations from the product assortment computing device 102 via delivery server 104. The delivery server 104 can, for example, provide services to the user via a workbench. The workbench can be a web-based tool or other micro-service that provides the product assortment recommendations to the user. The user can provide inputs such as business consideration inputs. The inputs provided by the user can also include a category of the products, a store, a store cluster and/or a product. In other examples, the inputs can include other data or information that can define a scope of the product assortment recommendations or provide limitations or other restrictions that can affect the product assortment recommendations.

The workbench can be provided to the user via the delivery server 104. The delivery server 104 can, for example, be a web server and/or cloud server that hosts the workbench for access to the user on the workstation 108. The delivery server 104 can be coupled to the product assortment computing device 102. The product assortment computing device 102 can be connected to the product information server 106 and/or to the database 110. The product information server 106 can provide various types of information or data that may be needed to determine the product assortment recommendations according to the methods described in the present disclosure. The database 110 can also provide a repository of data and/or information for use by the product assortment computing device 102. The product information server 106 and/or the database 110 can be coupled to other systems and/or devices of the retailer and/or partner merchants. The product information server 106 and/or the database 110 can, for example, be connected to forecasting tools, inventory management tools, customer information systems, historical sales repositories, and the like that can supply data and/or information as further described below.

The product assortment computing device 102 can include one or more modules, engines and/or services that can perform various aspects of the methods of the present disclosure. In the example shown, the product assortment computing device 102 includes a data acquisition engine 302 and optimization engine 304. The data acquisition engine 302 can operate to obtain and/or deliver information and data from the product assortment computing device 102 to the various other elements of the product assortment recommender system 300. The data acquisition engine 302 can include, for example, various application protocol interfaces (APIs) that can allow the product assortment computing device 102 to retrieve information from the product information server 106 and/or from the database 110. The data acquisition engine 302 can allow the product assortment computing device to retrieve information from other data sources, computing device and/or databases that may not be shown. The data acquisition engine 302 can also allow the product assortment computing device 102 to share or deliver information to the other elements of the product assortment recommender system 300. In some examples, the data acquisition engine 302 can also operate to perform transformations or otherwise modify the data before the data is used by the product assortment computing device 102 or is delivered to another element of the product assortment recommender system 300. The data acquisition engine 302 can aggregate data, normalize data, truncate data, and/or gap fill the data, for example.

The optimization engine 304 of the product assortment computing device 102 can perform various mathematical determination and/or perform optimization functions in order to determine the product assortment recommendations. For example, the optimization engine 304 can include or access various optimization libraries or optimization tools that are known to one of ordinary skill in the art. The optimization engine 304, as further described below, can use the data obtained by the data acquisition engine 302 and the inputs received from the user to determine product assortment recommendations.

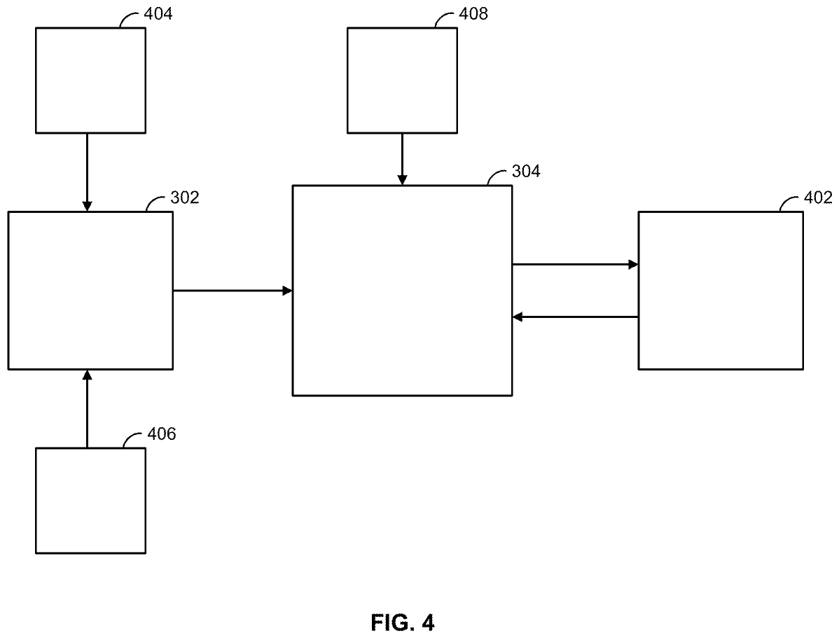

Turning now to FIG. 4, an example optimization engine 304 is shown. The optimization engine 304 can operate to determine product assortment recommendations as previously described. In this example, the optimization engine 304 can be connected to the data acquisition engine 302. The data acquisition engine 302 can obtain data and information from a variety of sources. The optimization engine 304 can also be connected to a workbench 402. The workbench 402 can be displayed or provided on a user's workstation (e.g., personal computer, laptop, tablet, mobile phone, etc.) to allow the user to access the services provided by the optimization engine 304 such as delivering customized product assortment recommendations.

An example process of providing product assortment recommendations can begin when a user accesses the workbench 402. The workbench 402 can include a graphical user interface (GUI) that can accept one or more assortment inputs that can allow the user to customize the product assortment recommendations. The user can, for example, use the workbench 402 to request product assortment recommendations and include with the request a timeframe, a category of products, a selection of stores (or group of stores), items to exclude from the product assortment and new items to include in the product assortment. In other examples, these assortment inputs can include other parameters, limitations or restrictions to further or alternatively customize the product assortment. The user can also include other business considerations in the assortment inputs. Such business considerations can include inputs to weigh units sold versus revenue versus profit. Another business consideration can include an input to weigh replenishment costs in the product assortment. In still other examples, other business considerations can be included in the inputs such as regulatory requirements and distribution constraints.

These assortment inputs can be obtained by the optimization engine 304 from the workbench 402. The optimization engine 304 can also obtain forecast data from the data acquisition engine 302. The data acquisition engine 302 can obtain forecast data from a forecast engine 404. The forecast engine 404 can be any suitable system, database, data table, or the like that determines product sales forecasts. Such forecast engines 404 can be an existing system of the retailer, for example. In other examples, the forecast engine 404 can be a service provided by a vendor or other service provider. The forecast data may need to be aggregated, normalized or gap-filled prior to being provided to the optimization engine 304. The data acquisition engine 302 can perform such operations to provide the forecast data in a suitable format and that meets the requirements of the assortment inputs provided by the workbench 402.

The forecast data can include several different types of information that projects the sales of products that may be included in the product assortment. The forecast data can include, for example, a forecast of demand in terms of units sold, a forecast of revenue, and/or a forecast of profit. This forecast data can be provided for each product, for each store and/or for each category of product. This information can, in turn, be provided to the optimization engine 304 by the data acquisition engine 302.

The data acquisition engine 302 can provide other data to the optimization engine 304. Such additional information can include, for example, product data, store data, customer data, distribution information, replenishment data and other information. The product data may include information that describes the type, brand, size, weight, cost, and other information. The store data can include information that describes a particular retail store location such as a geographic location, a size of the store, size of departments of the store, types of racks, displays, shelves, etc. The customer data can include customer purchasing behavior information, demographic information and the like. Distribution information can include, for example, supply chain information such as information describing a distribution center that may serve a store or group of stores, the frequency of delivery of products, cost of delivery and the like. Replenishment data can include cost information that describes the cost of re-stocking a product when the quantity of products being displayed is depleted. Replenishment data may also account for potential lost sales due to items being out of stock. Such replenishment data can be provided for each product, for each store, and/or for each product. The replenishment data can also include a facing count that describes a number of products that are currently being displayed in an existing product assortment.

A demand transference engine 408 may also be connected to the optimization engine 304. The demand transference engine 408 can provide demand transference data to the optimization engine 304. The demand transference data can characterize a change in demand of a first item that occurs when the availability of second product changes. For example, in the context of grocery items, demand transference can be explained using two brands of a cola beverage. In a particular store, brand X cola beverage may be sold and displayed in an aisle in which brand Y cola beverage is also sold. Demand transference can describe the change in demand that occurs to brand X cola when brand Y cola is unavailable. As can be appreciated, some customers may switch and buy brand X cola when brand Y cola is unavailable (either not displayed or the item stock has been depleted). In such an example, the demand for the unavailable brand Y cola has been “transferred” to brand X. Such a transfer may not be necessarily 1 to 1 since some customers prefer brand Y and will not switch to brand X.

In one example, demand transference can be describe using a demand transference coefficient that describes the amount of demand that transfers to a first item when a second item is unavailable. The demand transference engine 408 can determine such demand transference data or demand transference coefficients. In one example, the demand transference engine 408 can be connected to a substitution engine (not shown). Some retailers may have an existing substitution engine that determines customer preferences for substitute items that can be substituted or recommended to customers when an item becomes unavailable for purchase. The demand transference engine 408 may obtain substitution data from such substitution engines to determine demand transference data. This information can be provided to or obtained by the optimization engine for incorporation into the determination of product assortment recommendations.

The optimization engine 304 can use the data and/or information from the data acquisition engine 302 and/or the demand transference engine 408 to determine product assortment recommendations. The optimization engine 304 may determine the product assortment recommendations using any suitable methodology or algorithm. In one example, the optimization engine 304 determines the product assortment recommendations by solving or optimizing a product sales function. Depending on the input by the user when a product assortment recommendation is requested, the product sales function may optimize or maximize product units sold, revenue generated and/or profit. These different measures of product sales can also be weighed (i.e., given different percentages or relative weighing parameters) to determine the product assortment recommendations. The product assortment recommendations can be determined, for example, by solving this complex problem as an integer programming problem. The integer programming problem can be solved and/or optimized using optimization packages, libraries or tools known to one of ordinary skill in the art.

In one example, the product assortment recommendations may be determined using a product sales function such as that shown in Equation 1 below.

$$max {\sum }_{i ∈ I} {s}_{i} {x}_{i} + {\sum }_{i ∈ I} {\sum }_{j ∈ J} {s}_{i} {p}_{ij} ( 1 - {x}_{i} ) {x}_{j} \qquad Equation 1$$

$$such that {\sum }_{i ∈ I} {\sum }_{n = {l}_{i}}^{{u}_{i}} {w}_{i , n} {y}_{i , n} \leq L \qquad Limitation 1$$

$${\sum }_{i ∈ I} {\sum }_{n = {l}_{i}}^{{u}_{i}} {c}_{i , n} {y}_{i , n} \leq R where \qquad Limitation 2$$

$${\sum }_{n = {l}_{i}}^{{u}_{i}} {y}_{i , n} = {x}_{i} ∀ i ∈ I$$

$$\begin{matrix}{x}_{i} ∈ \{ 0 , 1 \} & ∀ i ∈ I \\ {y}_{i , n} ∈ \{ 0 , 1 \} & ∀ i ∈ I , ∀ n ∈ \{ {l}_{i} , … , {u}_{i} \}\end{matrix}$$

In this example, I is the set of products that could be recommended. The decision variable x defines whether or not any product i actually is recommended. The other decision variable y defines, more specifically, whether or not precisely n facings of product i are recommended. The recommendation system selects values for the decision variables. Necessary input data, known as model parameters, include l and u, the lower and upper bounds on the number of facings recommended for each product. There is also c, the replenishment cost when a certain number of facings of a certain product are carried, and R, the maximum allowable replenishment cost. (Replenishment costs will generally decrease as facing counts increase.) Other model parameters include w, the space taken up by a certain of facings of a certain product, and L, the maximum available space. Finally there is s, the sales or other business benefits that result when a certain product is carried, and p, the fraction of the benefits of product i that are captured via demand transference when product i is not carried but product j is carried.

The optimization engine 304 can optimize the sales function shown above as Equation 1 subject to Limitation 1 and Limitation 2 shown above. The sales function of Equation 1 incorporates not only a projected or forecasted sales (i.e., direct sales) of product xᵢ but also additional demand transference that may occur due to changes to other projects xⱼ where the coefficient pᵢⱼ represents a demand transference coefficient between products i and j. In addition, Limitation 1 limits the product assortment recommendations (i.e., the quantities of products recommended to be displayed on shelving, racks, etc.) to those products and their respective quantities that can fit on or into the space limitations of the relevant store space that is available. Furthermore, Limitation 2 limits the product assortment recommendations to a replenishment cost R that can be customized by the user (via the workbench 402) when the product assortment is requested. The replenishment cost represents the cost associated with having to re-stock items in the store when the available quantity of products has been removed and/or purchased by customers. As can be appreciated, the cost to replenish stock is associated with the cost to have a worker in the store re-stock the item on a shelf, rack or other display. As can be appreciated, such costs can vary from store to store and/or from product to product based on local labor costs, the time required to perform the re-stocking task, and/or to other variations.

The product assortment can therefore be determined using an optimization function that accounts for demand transfer, replenishment costs and available shelf space. The optimization engine 304 in various embodiments has been tested and used to product assortment recommendations. The product assortment recommendations can be configured to deliver a result that includes a recommendation of which products to include in store, a location for each product, and/or a number of facings for each product. The product assortment recommendations can be used to create a planogram that can be used to configure the layout for each store. Using the foregoing tools and methodology, runtimes (i.e., the time to deliver the product assortment recommendations) has been significantly reduced from existing or traditional methods. In some existing methodologies, the runtime was more than 10 hours to complete. The apparatuses and methods of the present disclosure have been shown to deliver product assortment recommendations for the same quantity of products in less than 30 minutes. In other examples, the runtime of the apparatuses and methods of the present disclosure is less than 5 minutes.

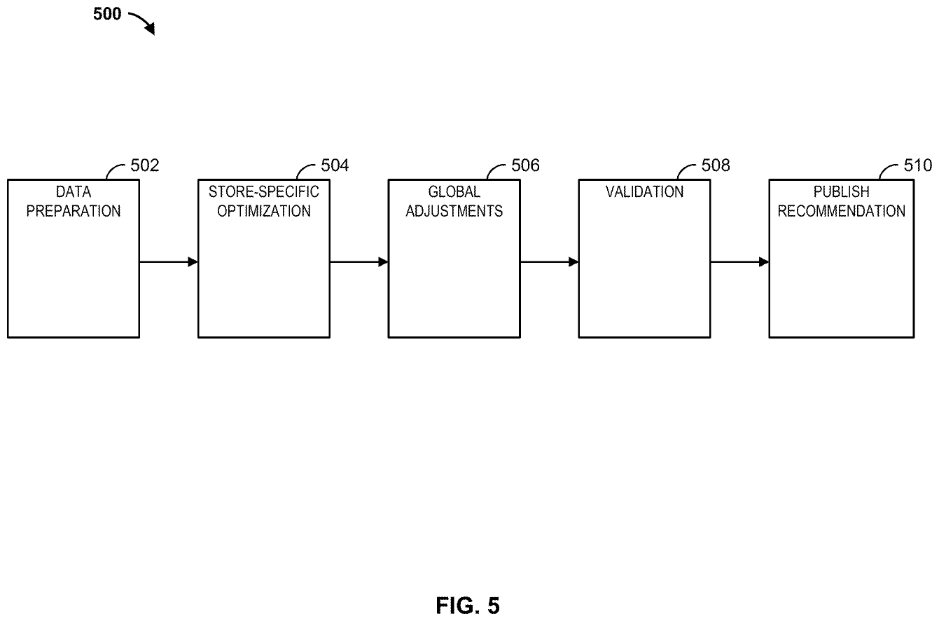

The product assortment systems of the present disclosure can be used to create product assortment recommendation in a number of methods. FIG. 5 illustrates one example method of determining product assortment recommendations. As shown, the method 500 can begin at step 502 with data preparation. At step 502, the data used by the optimization engine 304 can be obtained and prepared. The data can be obtained and prepared as previously described. In some examples, the data can be obtained by the data acquisition engine 302. The data may include forecast data, store (or shelf) data, replenishment cost data, demand transfer data and the like. The data can be normalized, gap-filled as may be required. The data may also include input data from a user that is requesting the product assortment recommendations.

At step 504, store-specific optimization is performed. Product assortment recommendations can be determined using the optimization engine 304 and/or by optimizing the product sales function. Such computations can be performed using automatic modeling and/or a commercial solver. The optimization cannot be performed by an individual because of the number of parallelized computations being performed simultaneously. The store-specific product assortment recommendations are specifically tailored for each store. Each store may have different layouts, different sizes and different sales projections. For at least these reasons, the product assortment recommendations can differ between stores. Some aspects of the product assortment recommendations, however, may be very similar between stores.

At step 506, global adjustments may be performed. As can be appreciated, there may be business constraints that can limit the ability of a retailer to offer different product assortments for each and every store. For example, the retailer may be constrained by the distribution centers that deliver products to the stores. In some instances, a distribution center is limited for costs reasons from stocking a product unless such a product is purchased and stored in a minimum order quantity. For this reason, a retailer may be constrained from offering a unique product in only one store location. Therefore, the retailer may not be able to offer unique product assortment in each store location. Furthermore, transportation requirements may require a minimum delivery quantity to be transported to each store. This may also affect the product assortment recommendation for a particular store.

At step 506, these business constraints are incorporated into the determination of product assortment recommendations. In some examples, the stores can be clustered into groups of stores. Such stores can be grouped to have the same product assortment recommendations. In one example, all stores that are serviced by the same distribution center is grouped into an cluster. In other examples, other methods can be used to cluster the stores into product assortment groups. Such other methods can include optimizing the product sales function (e.g., Equation 1) for the group. Another example method of clustering includes choosing one product assortment of the store-specific product assortments that is used for all stores in a particular cluster. The store-specific product assortment that is used across all stores in a particular cluster can be chosen using any suitable optimization method such as maximizing sales, revenue and/or profit for the cluster. In other examples, other suitable methods can be used. For example, stores that have approximately the same shelf, rack and other display space allocated for different product categories (as may be determined by a percentage difference of less than a predetermined amount) can be grouped together. The product assortments that performs the best across the cluster can be provided as a product assortment recommendation for each store in the cluster.

At step 508, validation can be performed. The step of validating the product assortment recommendations can include one or more checks that can be performed to ensure that the product assortment recommendations meet one or more requirements or limitations that may be chosen or may be in place given strategic considerations, business needs, physical limitations, and the like. For example, the product assortment recommendations that are determined after the global adjustments 506 can be compared to store data to ensure that the physical limitations of a particular store are not violated. This can be, for example, to ensure that the store has the physical space to hold and/or display the products in the product assortment recommendations. The product assortment recommendations can also be tested to ensure that replenishment costs at stores are not excessive (e.g., that replenishment costs are greater than a predetermined value) and that operational constraints at distribution centers are not violated. The product assortment recommendation can also be used to forecast future sales, revenue profits, and other business measures which can be compared to historical or baseline data to ensure that business objections are being met.

Once the product assortment recommendations are validated, the product assortment recommendations can be published at step 510. The product assortment recommendations can be published using any suitable method. In one example, the product assortment recommendations can be published via graphical user interface (GUI) of the workbench 402. Such a workbench can be displayed and/or provided to the user via the delivery server 104 (FIGS. 1 and 2). In other examples, the product assortment recommendations can be emailed, sent via instant message, sent via SMS, or communicated using other suitable methods. In still other examples, the product assortment recommendations can be provided in a visual format via an image, rendering, planogram or other suitable graphic format.

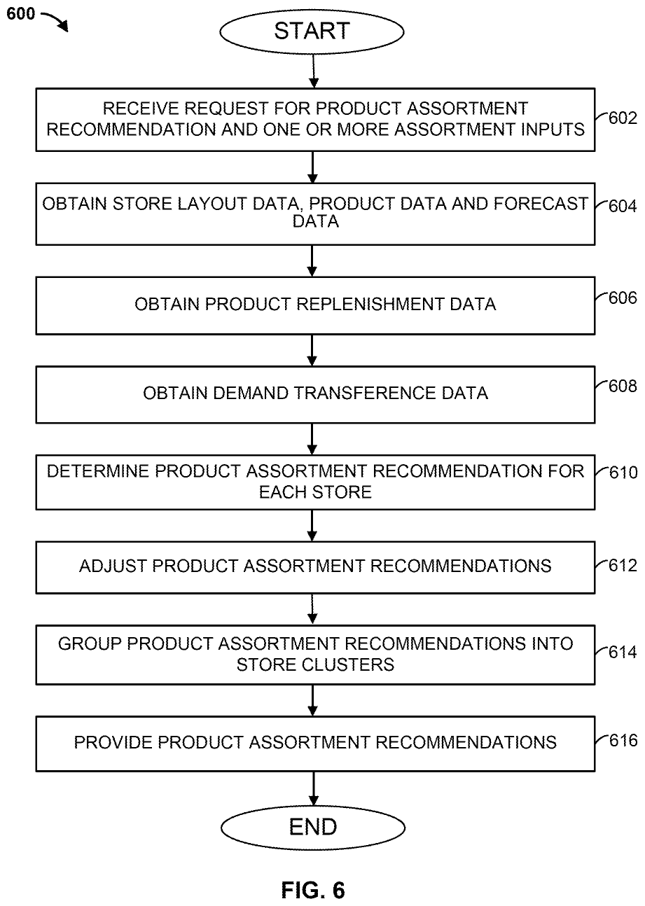

Another example method 600 of determining product assortment recommendations is shown in FIG. 6. The method 600 can be performed using one or more elements of the product assortment recommender systems described above. While various apparatuses and systems can be used, the method 600 is described with reference to the product assortment recommender system 300 and the example shown in FIGS. 3 and 4. It should be appreciated, however, that other variations and other systems and apparatuses can be used.

The method 600 begins at step 602 at which the product assortment computing device 102 may receive a request for product assortment recommendations and may also receive one or more assortment inputs. The request for product assortment recommendations may be initiated by a user of the workbench 402. Once the request is initiated by a user on the workbench 402, the request can be sent or otherwise routed to the product assortment computing device 102. In other examples, the request can be automatically initiated and received by the product assortment computing device. The request may be automatically generated according to predetermined schedule (e.g., daily, weekly, monthly, quarterly, annually, etc.). The request can also be initiated by some other event or other activity. For example, the request can be automatically initiated when a user opens or starts the workbench. In still other examples, the request can be initiated when a new product is added to a catalog of products or when a product is deleted from a catalog of products. In yet other examples, the request can be initiated when a sales, revenue, or profit target is not achieved by one or more stores of the retailer.

The one or more assortment inputs can also be provided by the user via the workbench 402. The one or more assortment inputs can include information that allows the user to customize the product assortment recommendations that are determined by the product assortment computing device 102. For example, the one or more assortment inputs may be directed to a business or strategic consideration of the retailer. The retailer may have a strategic or business goal to maximize units sold for a particular time frame. Alternatively, the retailer may desire to maximize revenue generated for a particular region. In another instance, the retailer may desire to maximize profit generated. The one or more assortment inputs can include information to direct the product assortment computing device 102 to determine the product assortment recommendations with these business or strategic considerations. The one or more assortment inputs can be a parameter or coefficient that is used by the product assortment computing device during the optimization of the product assortment recommendations.

The one or more assortment inputs may also be directed to customization by limiting or selecting a particular category, brand or type of products to be considered. The one or more assortment inputs may also allow a user to select a particular store, group of stores, geographic region, distribution center, or other characteristic of the stores for which the product assortment recommendations will be generated. Such inputs can be collected and sent to the product assortment computing device 102 from the workbench 402. In some examples, the delivery server 104 can assist with the transfer of information from or to the product assortment computing device 102.

The method 600 may continue to step 604 at which the product assortment computing device 102 may obtain store layout data, product data and forecast data. The product assortment computing device 102 can obtain such data from any suitable source. In some examples, the store layout data can be obtained from database 110 or other repository of information. The store layout data can be stored and maintained by an operations department of the retailer, for example. The store layout data can include various types of information such as a location of the store, size of the store, a footprint of the store, size of various departments in each store, types of racks, shelves, and other product displays, size of racks, shelves and other product displays, and/or numbers of racks, shelves and other product displays. The store layout data can include other types of the information as well that may be needed to determine the location in which existing products are displayed and maintained in the various store locations.

The product data can include various types of information that describe characteristics of each product sold by the retailer in a store. The product data may include taxonomy information that categories the products into predetermined, categories and sub-categories. The product data may also include information regarding the type, size, brand, and other information. The product data may also describe the current display of the product in a store such as location, number of facings, and the like. The forecast data can include information that describes projected sales, orders, and/or inventory for each product. The forecast data include future estimates or projects of the demand for each product. The product data and the forecast data can be stored and maintained by internal departments of the retailer and stored in database 110, product information server 106 or other suitable location. In other examples, the product data and/or the forecast data may be stored and maintained by a third-party or service provider.

The method 600 may continue to step 606 at which the product assortment computing device 102 may obtain product replenishment data. In some examples, the product replenishment data can be obtained by the data acquisition engine 302. The product replenishment data can characterize a cost to re-stock products on the racks, shelves, or other displays in a store. The replenishment data may also account for lost sales due to products being unavailable due to depleted stock. The product replenishment data may be maintained and/or stored by the retailer or by a third-party. The product replenishment data can be obtained, for example, from the database 110 and/or from the product information server 106.

The method 600 may continue to step 608 at which the product assortment computing device 102 obtains demand transference data. In some examples, the demand transference data can be obtained by the data acquisition engine 302. In another example, the demand transference data is obtained from the demand transference engine 408. The demand transference data can include information that describes a change in demand of a first product when the availability of a second product changes (e.g., is unavailable or has limited availability). The demand transference data may be maintained and/or stored by the retailer or by a third-party.

The method 600 may continue to step 610 at which the product assortment computing device 102 can determine product assortment recommendations. Such product assortment recommendations can be determined for any suitable basket of products such all products for a store, all products for category or department of products, all products for a sub-category of products or the like. The product assortment can be limited or customized according to the one or more assortment inputs that are received at step 602. The product assortment recommendations are based on the store layout data, the product data, the forecast data, the product replenishment data and/or the demand transference data. In other examples, other data can also be used to determine the product assortment recommendations such as the one or more assortment inputs, a business or strategic consideration, customer behavior data, customer demographic data, geographic data, distribution center data and the like. In some examples, the product assortment recommendations can be determined using a product sales function. In some examples, the product sales function can be characterized by Equation 1 described above. The product assortment recommendations can be formatted and/or stored for further access and use.

The product assortment recommendations can describe a set of products from an available catalog of products that should be provided for sale in a store to optimize the selected goal of the retailer such as maximizing units sold, revenue generate, or profit generated. In other examples, other goals and/or targets can be used to determine the product assortment recommendations such as lowest cost, minimized store space, or the like. The product assortment recommendations can describe various aspects of the products recommended to be displayed and/or sold such as location of product in store, type of product, size of product, category of product, number of facings for each product, cost of product, brand of product and other identifying or descriptive information.

The method 600 may continue to step 614 at which the product assortment computing device may group the product assortment recommendations into store clusters. The product assortment recommendations may be grouped into the store clusters using any suitable method or process such as those described above with respect to method 500.

At step 616, the product assortment recommendations can be provided by the product assortment computing device 102 to the user. In some examples, the product assortment recommendations can displayed to the user via graphical user interface (GUI). The product assortment computing device 102 can display or provide the product assortment recommendations in any suitable format. In some examples, the product assortment recommendations are displayed as a list of products with relevant information as previously described. In other examples, the product assortment recommendations can be provided in a graphical format such as in a planogram. In still other examples, other formats or displays can be used. In one example. the product assortment recommendations are displayed on a workstation of the user by the delivery server 104 via the workbench 402.

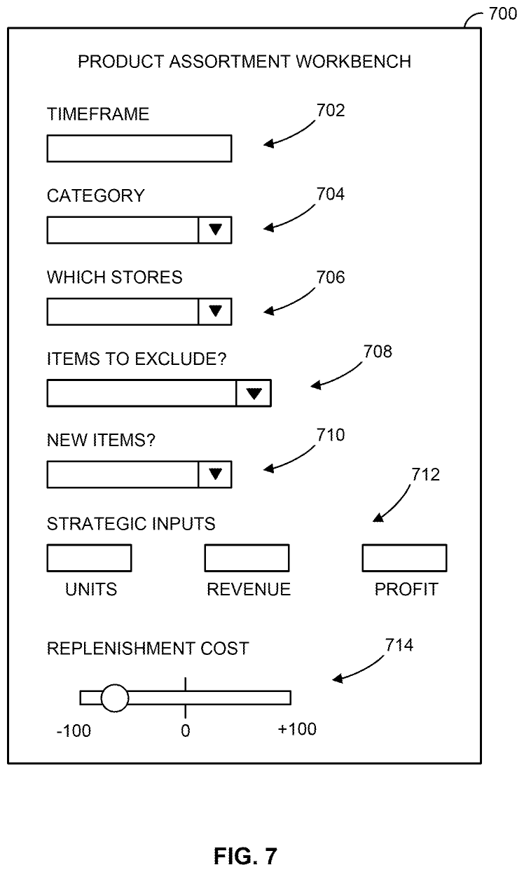

Turning now to FIG. 7, an example user interface 700 is shown. The graphical user interface (GUI) 700 can be part of the workbench 402 that can be used by a user to request product assortment recommendations and/or to view the product assortment recommendation that are determined and/or optimized by the product assortment computing device 102. As shown, the GUI 700 may include multiple controls and/or input fields that allow the user to customize a request for product assortment recommendations. In the example shown, the GUI 700 includes a timeframe input field 702, a category input 704, a store selector 706, an item excluder 708, a new item selector 710, strategic consideration inputs 712 and a replenishment cost selector 714. In other examples, the GUI 700 can include other inputs and selectors or may include other types of inputs or selectors different than or in addition to the ones described below.

The timeframe input 702 may be included and allow the user to select a timeframe for the product assortment recommendations. The time frame input 702 can allow a user to enter a timeframe or may allow the user to use a pull-down list or calendar function to select a timeframe. Various retailers may allow or desire to change product assortments in stores at various intervals. The timeframe input 702 can allow the user to select a desired timeframe such as for the next month, quarter, year or other period of time.

The category input 704 may also be included in the GUI 700 and may allow the user to select a category of products for which the product assortment recommendations are desired. The category input 704 may allow a user to select a category of products from a retailer's existing taxonomy of its product catalog. The category input 704 may allow a user to select a department of products into which products are organized in the store. The category input 704 can allow the user to select any suitable grouping of products such as by descriptive category (e.g., grocery, housewares, sporting goods, womens' clothing, etc.). Alternatively, the category may allow products to be selected by a location in the store such as an aisle or shelf (e.g., frozen food aisle, beverage aisle, dairy section, produce section, etc.). The store selector 706 may allow a user to select or request product assortment recommendations for a particular store, group of stores, geographic location or the like.

The item excluder 708 or the new item selector 710 may allow particular items to be excluded or added to the product assortment recommendations, respectively. In some situations, a user may desire to force a new product to be added in the product assortment recommendations. Data or information may be limited for new product and the normal optimization processes of the product assortment computing device 102 may not include such new products in the product assortment. The new item selector 710 may force new items to be included in the product assortment. Alternatively, a user may know that a product is going to be discontinued or that the retailer does not desire to continue to provide a specific product. The user can exclude products from the product assortment recommendations using the item excluder 708.

The strategic consideration inputs 714 may allow the user to include business and/or strategic considerations in the determination of the product assortment recommendations. In the example shown, the strategic consideration inputs 714 allow the user to weigh units sold versus revenue generated versus profit generated in the determination of the product assortment recommendations. For example, a relative percentage, coefficient, or weight factor can be entered or selected by the user using the strategic consideration inputs 712. This information can be used to weigh aspects of a product sales function or otherwise determine the product assortment recommendations. The strategic consideration inputs 712 can allow the user to input other strategic goals or targets in other examples.

The GUI 700 may also include the replenishment cost selector 714. The replenishment cost selector 714 can allow the user to determine a weight or factor that is used to incorporate replenishment cost of a product into the determination of the product assortment recommendations. In the example shown, the replenishment cost selector 714 is provided as a slider. The slider can allow the user to select a weigh factor from −100 to +100. In other examples, other factors or measures can be used. In the example shown, the user can increase or decrease the relative weight that is given to the replenishment cost in the determination of the product assortment recommendations. If the user desires to increase the impact of replenishment cost, the user can move the slider to +100 (or to any other positive value along the slider). If the user desires to decrease the impact of replenishment cost, the user can move the slider to −100 (or to any other negative value along the slider). If the user, desires to maintain the existing impact of replenishment cost, the user can set the slide at zero.

The user may desire to change the impact of replenishment cost due to a variety of business reasons. In one circumstance, the user may learn that a particular store (or group of stores) is performing poorly because products need to be continuously re-stocked or because a store does not have adequate personnel to re-stock its shelves and displays. In such a circumstance, the user may want to increase the impact of replenishment cost to result in a recommended product assortment that results in a decreased frequency of re-stocking. The user may move the slider to a positive value on the slider 714 and receive product assortment recommendations accordingly. In other circumstances, the user may want to decrease the impact of replenishment cost by moving the slider 714 to a negative value.

After a user selects and/or sets the various controls of the GUI 700 as desired, the user can request that product assortment recommendation be delivered accordingly. The assortment inputs (as selected by the user on the GUI 700) can be incorporated into the product assortment process. The product assortment recommendations can then be delivered or displayed to the user.

The apparatuses and methods of the present disclosure provide many advantages over existing or traditional methods of determining product assortments. The apparatuses and methods of the present disclosure can obtain, aggregate, and prepare the vast amounts of data required for the optimization of product assortment whereas existing or traditional methods require shortcuts, experience, rules of thumb or the like. The apparatuses and methods of the present disclosure can allow a user to iteratively obtain product assortment recommendations that allow the user to weigh different business or strategic considerations. Furthermore, the optimization methods of the present disclosure account for replenishment cost and for demand transference. The users of the apparatuses and methods of the present disclosure can easily interact with the underlying complex methodologies using a cloud-based or remote service without the need for locally installed software or models. The graphical user interfaces of the product assortment recommender system allow the user to easily input customized inputs and receive product assortment recommendations.

Although the methods described above are with reference to the illustrated flowcharts, it will be appreciated that many other ways of performing the acts associated with the methods can be used. For example, the order of some operations may be changed, and some of the operations described may be optional.

In addition, the methods and systems described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The term model as used in the present disclosure includes data models created using machine learning and/or artificial intelligence. Machine learning may involve training a mathematical model in a supervised or unsupervised setting. Machine learning models may be trained to learn relationships between various groups of data. The models may be based on a set of algorithms that are designed to model abstractions in data by using a number of processing layers. The processing layers may be made up of non-linear transformations. Machine learning models may include, for example, neural networks, convolutional neural networks and deep neural networks. Such neural networks may be made of up of levels of trainable filters, transformations, projections, hashing, and pooling. The models may be used in large-scale relationship-recognition tasks. The models can be created by using various open-source and proprietary machine learning tools and/or libraries known to those of ordinary skill in the art.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
at least one computing device configured to:
obtain store layout data, product data and forecast data, the forecast data characterizing projected sales information for the products described in the product data;
obtain demand transference data characterizing changes in demand for one or more products when a different product is unavailable;
obtain product replenishment data characterizing a cost to re-stock products;
determine a recommended product assortment for the products described in the product data for each store described in the store layout data based on the forecast data, the demand transference data, and the product replenishment data; and
display the recommended product assortment.

2. The system of claim 1, wherein the recommended product assortment is determined by an optimization engine configured to optimize a product sales function.

3. The system of claim 2, wherein the product sales function is described by the equation:
$$max {\sum }_{i ∈ I} {s}_{i} {x}_{i} + {\sum }_{i ∈ I} {\sum }_{j ∈ J} {s}_{i} {p}_{ij} ( 1 - {x}_{i} ) {x}_{j}$$

4. The system of claim 1, wherein the at least one computing device is further configured to display an input graphical user interface (GUI) that includes one or more input fields configured to obtain one or more assortment inputs, the one or more assortment inputs characterizing one or more strategic business considerations.

5. The system of claim 4, wherein the one or more strategic business considerations comprises a weight of units sold versus revenue versus profit.

6. The system of claim 4, wherein the input graphical user interface (GUI) comprises a replenishment slider configured to allow a user to change the weight given to the product replenishment data when the recommended product assortment is determined.

7. The system of claim 1, wherein the at least one computing device is further configured to group the recommended product assortments into two or more store clusters.

8. The system of claim 7, wherein two or more store clusters are determined based on one or more distribution limitations.

9. A method comprising:
obtaining store layout data, product data and forecast data, the forecast data characterizing projected sales information for the products described in the product data;
obtaining demand transference data characterizing changes in demand for one or more products when a different product is unavailable;
obtaining product replenishment data characterizing a cost to re-stock products;
determining a recommended product assortment for the products described in the product data for each store described in the store layout data based on the forecast data, the demand transference data, and the product replenishment data; and
displaying the recommended product assortment.

10. The method of claim 9, wherein the recommended product assortment is determined by an optimization engine configured to optimize a product sales function.

11. The method of claim 10, wherein the product sales function is described by the equation:
$$max {\sum }_{i ∈ I} {s}_{i} {x}_{i} + {\sum }_{i ∈ I} {\sum }_{j ∈ J} {s}_{i} {p}_{ij} ( 1 - {x}_{i} ) {x}_{j}$$

12. The method of claim 9, wherein the at least one computing device is further configured to display an input graphical user interface (GUI) that includes one or more input fields configured to obtain one or more assortment inputs, the one or more assortment inputs characterizing one or more strategic business considerations.

13. The method of claim 12, wherein the one or more strategic business considerations comprises a weight of units sold versus revenue versus profit.

14. The method of claim 12, wherein the input graphical user interface (GUI) comprises a replenishment slider configured to allow a user to change the weight given to the product replenishment data when the recommended product assortment is determined.

15. The method of claim 9, wherein the at least one computing device is further configured to group the recommended product assortments into two or more store clusters.

16. The method of claim 9, wherein two or more store clusters are determined based on one or more distribution limitations.

17. A non-transitory computer readable medium having instructions stored thereon, wherein the instructions, when executed by at least one processor, cause a device to perform operations comprising:
obtaining store layout data, product data and forecast data, the forecast data characterizing projected sales information for the products described in the product data;
obtaining demand transference data characterizing changes in demand for one or more products when a different product is unavailable;
obtaining product replenishment data characterizing a cost to re-stock products;
determining a recommended product assortment for the products described in the product data for each store described in the store layout data based on the forecast data, the demand transference data, and the product replenishment data; and
displaying the recommended product assortment.

18. The non-transitory computer readable medium of claim 17, wherein the recommended product assortment is determined by an optimization engine configured to optimize a product sales function.

19. The non-transitory computer readable medium of claim 18, wherein the product sales function is described by the equation:
$$max {\sum }_{i ∈ I} {s}_{i} {x}_{i} + {\sum }_{i ∈ I} {\sum }_{j ∈ J} {s}_{i} {p}_{ij} ( 1 - {x}_{i} ) {x}_{j}$$

20. The non-transitory computer readable medium of claim 17, wherein the operations further comprise displaying an input graphical user interface (GUI) that includes one or more input fields configured to obtain one or more assortment inputs, the one or more assortment inputs characterizing one or more strategic business considerations, wherein the one or more strategic business considerations comprises a weight of units sold versus revenue versus profit and the input graphical user interface (GUI) comprises a replenishment slider configured to allow a user to change the weight given to the product replenishment data when the recommended product assortment is determined.
